(19) United States
(12) Patent Application Publication
(10) Pub. No.: US 2008/0035610 A1
(43) Pub. Date: Feb. 14, 2008

(54) SUBSTRATE PROCESSING APPARATUS AND SUBSTRATE PROCESSING METHOD

(76) Inventors: Katsuhiko MIYA, Kyoto (JP); Akira IZUMI, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/774,302

(22) Filed: Jul. 6, 2007

(30) Foreign Application Priority Data
Aug. 11, 2006 (JP) 2006-220055

(51) Int. Cl. C23F 1/00; B44C 1/22

(52) U.S. Cl. 216/84; 156/345.17; 156/345.21

(57) ABSTRACT

The substrate processing apparatus includes a first etching mode and a second etching mode. In the first etching mode, a first nozzle is positioned at a first processing position and a chemical solution is supplied from the first nozzle to a top rim portion of the rotating substrate. In the second etching mode, a second nozzle is positioned at a second processing position and DIW is supplied to the top rim portion to which the chemical solution adheres, while the chemical solution is supplied from the first nozzle positioned at the first processing position to the top rim portion of the rotating substrate. The etching mode is selectively switched between the two etching modes in accordance with a property of the thin film adhering to the substrate.

### CROSS REFERENCE TO RELATED APPLICATION

The disclosure of Japanese Patent Application No. 2006-220055 filed Aug. 11, 2006 including specification, drawings and claims is incorporated herein by reference in its entirety.

### BACKGROUND OF THE INVENTION

1. Field of the Invention

The present invention relates to a substrate processing apparatus and a substrate processing method which supplies a processing liquid such as a chemical solution and a rinsing liquid to a substrate to thereby perform a predetermined processing to the substrate, the substrate including semiconductor wafers, glass substrates for photomask, glass substrates for liquid crystal display, glass substrates for plasma display, substrates for FED (field emission display), substrates for optical disks, substrates for magnetic disks, substrates for magnet-optical disks, etc.

2. Description of the Related Art

In a production process in which a series of processing is performed to the substrates such as semiconductor wafers, a film forming processing is performed for the purpose of forming a various kinds of thin films on the substrate surface. In this film forming processing, the film is sometimes formed on a rear surface of the substrate or a rim portion of the substrate top surface. However, it is only a circuit-forming region at the central portion of the substrate top surface that requires the film to be formed on the substrate in general. And when the films are formed either on the rear surface of the substrate or on the rim portion of the substrate top surface, the following problems may occur. To be more specific, the thin film formed on a rim portion of the substrate top surface may peel off due to a contact with other apparatus during post-processing of the film forming processing. And, the peeled-off thin film may adhere to the circuit-forming region at the central portion of the substrate top surface and to the substrate processing apparatus, which may cause reduced yield of the fabricated products and a trouble of the substrate processing apparatus itself.

Consequently, an apparatus described in JP-A-2000-235948 for instance is proposed for the purpose of removing the thin film formed on the rear surface of the substrate and on the rim portion of the substrate top surface. According to this apparatus, a substrate with a thin film formed on its top surface is positioned facing up, and is held by a holding member provided corresponding to the rim of the substrate. Then, the substrate is rotated while being held by the holding member. Further, a chemical solution (first processing liquid) is supplied as a processing liquid to the rear surface of the rotating substrate. This causes the chemical solution to spread to the entire rear surface of the substrate so that the undesired substance on the rear surface of the substrate is removed by etching. Further, when a blocking member which includes an opposed surface opposed to the substrate top surface and is away from the substrate top surface by a predetermined distance is rotated, due to the rotation of the substrate and the rotation of the blocking member, the chemical solution flows from the rear surface of the substrate over to the rim portion of the substrate top surface via the edge surface of the substrate and removes even the undesired substance adhering to the rim portion. In this way, the thin film is removed by etching only from the substrate rear surface and the rim portion of the substrate top surface.

### SUMMARY OF THE INVENTION

Incidentally, the properties (the type of the thin film and the thickness of the thin film) of the thin film (undesired substance) which is subject to removal by etching are wide-ranging. With regard to the types of the thin films for example, there are various kinds of thin films different from each other including silicon nitride film (SiN film), insulating film (high-k film) which has higher relative permittivity than silicon oxide film, metal layer such as copper, and tetraethylorthosilicate (TEOS) film. Among them, SiN film and high-k film are hardly soluble in the chemical solution, whereas TEOS film can be relatively easily removed by etching by means of the chemical solution. Therefore, it is necessary to remove the thin film by etching at an appropriate etching rate in accordance with the type of the thin film. Because it becomes difficult to accurately control the width (hereinafter called “rim etching width”) inward from the edge surface of the substrate from which the thin film is removed by etching in the case where the etching rate is excessively high. And because the throughput is decreased greatly in the case where the etching rate is excessively low, on the other hand.

Consequently, it is necessary to prepare the chemical solution of the appropriate concentration in accordance with the type of the thin film in order to remove by etching various types of thin films at an appropriate etching rate in the conventional apparatus described above. However, it is not realistic to prepare a plurality of chemical solutions, each of which the concentration is different from each other, depending upon the number of the types of the thin film. Specifically, in the case where hydrofluoric acid is used as the chemical solution, the undiluted hydrofluoric acid (or liquid of hydrogen fluoride) and deionized water are supplied to a storage such as a tank while the respective flow rates are controlled so as to produce hydrofluoric acid of a predetermined concentration in the tank. Hence, in the case where a processing is performed with highly-concentrated hydrofluoric acid after a processing is performed with hydrofluoric acid of relatively low concentration, it is necessary to drain the hydrofluoric acid of low concentration stored in the tank to replace with the hydrofluoric acid of high concentration. Therefore, time is consumed just for replacing the solution in the tank, and the consumption amount of the chemical solution (hydrofluoric acid) increases. Further, even though the flow rates of the hydrofluoric acid and deionized water are controlled in order to produce the hydrofluoric acid, it does not necessarily mean that the chemical solution (hydrofluoric acid) of the desired concentration can be prepared with no difficulty in the range from low concentration to high concentration because the range of the flow rates the apparatus can set is limited. Therefore, it has been virtually impossible to prepare a chemical solution of a concentration optimized for the thin film formed on the substrate.

Consequently, the possible solution is to prepare a chemical solution of relatively high concentration in order to perform the etching processing to each of a plurality of substrates to which the thin films adhere, of which the types are different from each other, that is, a plurality of substrates in which the types of the thin films adhering to the respective substrates are different from each other. Because it is possible to perform the etching processing not only to the substrates to which the thin film which can be relatively easily removed by etching adhere, but also to the substrates to which the thin film poorly soluble in the chemical solution adhere, by preparing the chemical solution of relatively high concentration. This makes it possible to remove the thin films by etching from each of a plurality of substrates to which the thin films adhere, of which the types are different from each other, without decreasing the throughput.

However, the following problem may occur in the case where the etching processing is also performed to the substrate to which the thin film which can be removed by etching relatively easily adhere by means of the relatively highly concentrated chemical solution. To be more specific, the etching rate of the thin film may become too high, and it may be impossible to accurately control the rim etching width. Therefore, even if the chemical solution of relatively high concentration is prepared, it is not in the situation that the undesired substance is excellently removed by etching from the rim portion of the substrate top surface depending upon the property of the thin film (undesired substance) adhering to the substrate.

The invention has been made in light of the problem described above, and accordingly an object of the invention is to provide a substrate processing apparatus and method which can excellently remove by etching the undesired substance from the rim portion of the substrate top surface regardless of the property of the undesired substance adhering to the substrate.

According to a first aspect of the present invention, there is provided a substrate processing apparatus, comprising: a bevel etching section which supplies a first processing liquid to a rim portion of a substrate top surface and removes by etching undesired substance which is present on the rim portion by means of the first processing liquid to execute a bevel etching processing; an etching suppressing section which supplies a second processing liquid to the rim portion of the substrate top surface to which the first processing liquid adheres and substantially suppresses a progression of etching of the undesired substance by means of the first processing liquid to execute an etching suppressing processing, wherein the etching suppressing section executes the etching suppressing processing in accordance with a property of the undesired substance while the bevel etching section executes the bevel etching processing, and accordingly an etching rate of the undesired substance is adjusted.

According to a second aspect of the present invention, there is provided a substrate processing method, comprising: a bevel etching step of supplying a first processing liquid to a rim portion of a substrate top surface to remove undesired substance which is present on the rim portion by etching from the rim portion by means of the first processing liquid; and an etching suppressing step of supplying a second processing liquid to the rim portion of the substrate top surface to which the first processing liquid adhere to substantially suppress progression of etching of the undesired substance by means of the first processing liquid, wherein the etching suppressing step is executed in accordance with a property of the undesired substance while the bevel etching step is executed to adjust an etching rate of the undesired substance.

Meanwhile, an “etching rate of the undesired substance” of the invention is the value (quotient) the etching amount of the undesired substance is divided by the etching processing time during which the etching of the undesired substance is performed, or the value (quotient) the etching amount of the undesired substance is divided by the total processing time which is the sum of the etching processing time and the etching suppressing processing time during which the progression of the etching of the undesired substance is suppressed.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a diagram showing a first embodiment of a substrate processing apparatus according to the invention.

FIG. 2 is a block diagram showing a main control configuration of the substrate processing apparatus which is shown in FIG. 1.

FIG. 3 is a plan view of the spin base as viewed from above.

FIG. 4 is a partial enlarged view showing a structure of the support pin.

FIG. 5 is a bottom view of the blocking member.

FIG. 6 is a diagram showing structures of the first nozzle and the nozzle insertion hole which is provided in the blocking member.

FIGS. 7A and 7B are sectional views for describing the relationships between the outside diameters of the first and the second nozzles and the hole diameters of the nozzle insertion holes.

FIG. 8 is a flow chart showing an operation of the substrate processing apparatus shown in FIG. 1.

FIG. 9 is a flow chart showing a content executed in a first etching mode.

FIG. 10 is a flow chart showing a content executed in a second etching mode.

FIG. 11A is a plan view for describing a mechanism of a removal of a thin film by etching in the first etching mode.

FIG. 11B is a plan view for describing a mechanism of a removal of a thin film by etching in the second etching mode.

FIG. 12A is a timing chart showing a progression of etching in a micro region SR at respective timings in the first etching mode.

FIG. 12B is a timing chart showing a progression of etching in a micro region SR at respective timings in the second etching mode.

FIG. 13 is a plan view showing a second embodiment of the substrate processing apparatus according to the invention.

FIGS. 14A, 14B and 14C are diagrams schematically showing operations of the substrate processing apparatus shown in FIG. 13.

### DETAILED DESCRIPTION OF THE PREFERRED EMBODIMENTS

### First Embodiment

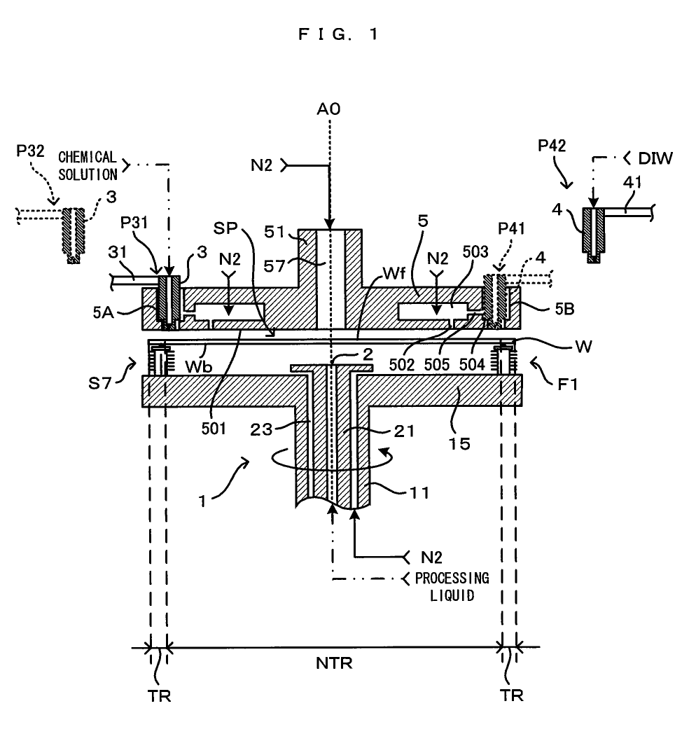

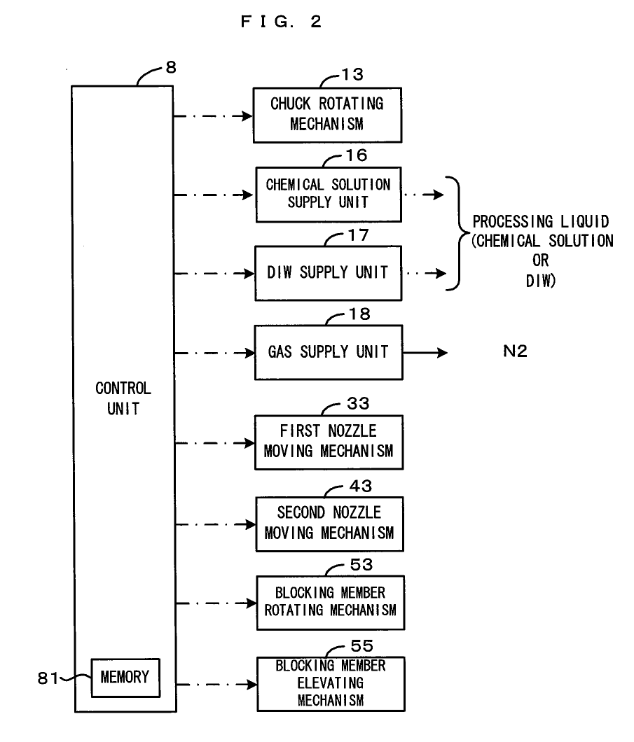

FIG. 1 is a diagram showing a first embodiment of a substrate processing apparatus according to the invention. FIG. 2 is a block diagram showing a main control configuration of the substrate processing apparatus which is shown in FIG. 1. This substrate processing apparatus is an apparatus which removes by etching a thin film (undesired substance) which is present on a rim portion of a top surface Wf of an approximately circular substrate W such as a semiconductor wafer or is present both on the rim portion and on a substrate rear surface Wb. The respective substrates W to be processed have a mutually different type of thin films formed on the substrate top surface Wf or on the both surfaces Wf and Wb, the thin films including SiN film, high-k film, metal layer such as copper, and TEOS film. Consequently, in the case where the thin film is formed only on the substrate top surface Wf, a chemical solution and a rinsing liquid such as DIW (deionized water) are supplied to a rim portion (processing region) TR of the substrate top surface Wf to thereby remove the thin film from the rim portion TR by etching (the chemical solution and the rinsing liquid are hereinafter collectively called the “processing liquid”), and the processing liquid is supplied to the substrate rear surface Wb to thereby clean the rear surface Wb. On the other hand, in the case where the thin film is formed on the both surfaces Wf and Wb of the substrate W, the processing liquid is supplied to the rim portion TR of the top surface and to the rear surface Wb to thereby remove the thin film by etching from the rim portion TR of the top surface and to the rear surface Wb. Meanwhile, the substrate top surface Wf means a device-formed surface on which a device pattern is formed in this embodiment. The rim portion TR of the top surface is also called “the top rim portion TR” hereinafter.

This substrate processing apparatus comprises a spin chuck 1, an under surface processing nozzle 2, a first nozzle 3, a second nozzle 4, and a blocking member 5. The spin chuck (corresponding to the “substrate holder” of the invention) 1 holds and rotates the substrate W approximately horizontally in a condition that the substrate top surface Wf is directed toward above. The under surface processing nozzle 2 supplies the processing liquid to a central portion in the under surface (rear surface Wb) of the substrate W which is held by the spin chuck 1. The first nozzle 3 supplies the chemical solution from the side of the substrate top surface to the top rim portion TR of the substrate W which is held by the spin chuck 1. The second nozzle 4 supplies DIW from the side of the substrate top surface to the top rim portion TR of the substrate W which is held by the spin chuck 1. The blocking member 5 is disposed opposed against the top surface Wf of the substrate W which is held by the spin chuck 1.

A hollow rotation column 11 of the spin chuck 1 is linked to a rotation shaft of a chuck rotating mechanism 13 which includes a motor. The spin chuck 1 is rotatable about a rotation center A0 when the chuck rotating mechanism 13 is driven. A spin base 15 is connected by a fastening component such as a screw to a top end portion of the rotation column 11 as one integrated unit. The spin base 15 therefore rotates about the rotation center A0 by driving the chuck rotating mechanism 13 in response to an operation command received from a control unit (controller) 8 which controls the entire apparatus. Thus, in this embodiment, the chuck rotating mechanism 13 functions as the “rotator” of the invention, and the spin base 15 functions as the “rotating member” of the invention.

A processing liquid supply pipe 21 is inserted in the hollow rotation column 11, and the under surface processing nozzle 2 is coupled with the top end of the processing liquid supply pipe 21. The processing liquid supply pipe 21 is connected with a chemical solution supply unit 16 and a DIW supply unit 17, and the chemical solution and DIW which serves as the rinsing liquid are selectively supplied. Further, a gap between an inner wall surface of the rotation column 11 and an outer wall surface of the processing liquid supply pipe 21 forms a ring-like gas supply path 23. The gas supply path 23 is connected with a gas supply unit (corresponding to the “gas supplier” of the invention) 18. Hence, it is possible to supply nitrogen gas to a space between the substrate rear surface Wb and a top surface of the spin base 15 which is opposed to the substrate rear surface Wb. Meanwhile, although the gas supply unit 18 supplies nitrogen gas in this embodiment, the gas supply unit 18 may supply air, other inert gas, etc.

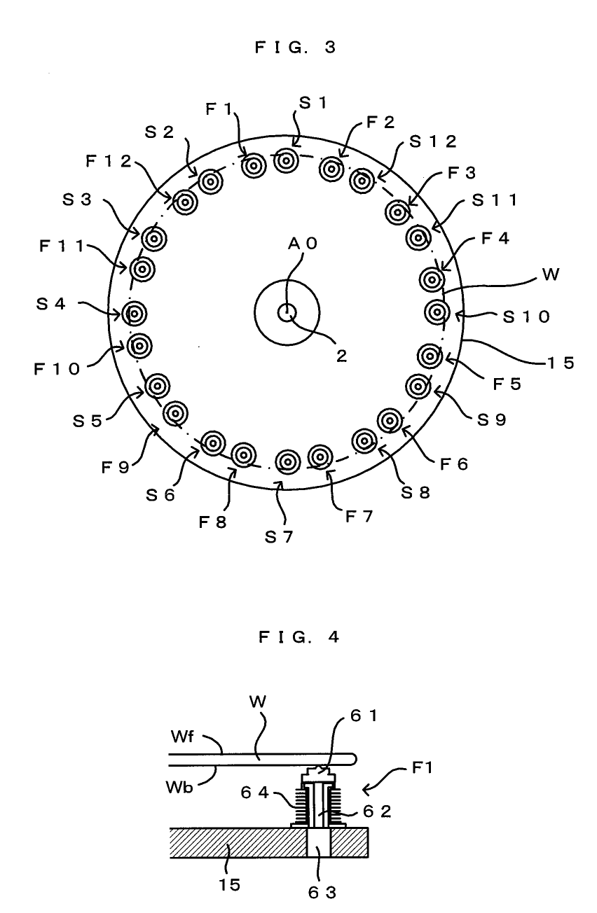

FIG. 3 is a plan view of the spin base 15 as viewed from above. There is an opening in a central portion of the spin base 15. Further, in the vicinity of a rim portion of the spin base 15, plural (twelve in this embodiment) first support pins F1 through F12 and plural (twelve in this embodiment) second support pins S1 through S12 are disposed such that they are capable of freely ascending and descending in the vertical direction. The support pins F1 through F12 and S1 through S12 function as the “support members” of the invention. The first support pins F1 through F12 are disposed projecting toward above from the spin base 15 in a circle around the rotation center A0 approximately equiangularly. The second support pins S1 through S12 are disposed projecting toward above from the spin base 15 in a circle around the rotation center A0 approximately equiangularly and are located between the first support pins F1 through F12. In short, twelve pairs of the support pins, each of which is one first support pin and one second support pin which are paired, are disposed in a circle around the rotation center A0 in the rim portion of the spin base 15 such that they project toward above.

Each of the first support pins F1 through F12 and the second support pins S1 through S12 abuts on the substrate rear surface Wb, which makes it possible to support the substrate W approximately horizontally in a condition that the substrate W is spaced apart by a predetermined distance toward above from the spin base 15. Of these pins, the twelve first support pins F1 through F12 disposed between every other second support pins along the circumference constitute the first support pin group. The first support pins F1 through F12 of the first support pin group operate together in supporting the substrate W or in moving away from the substrate rear surface Wb to release the substrate W from supporting. Meanwhile, the remaining twelve second support pins S1 through S12 constitute the second support pin group. The second support pins S1 through S12 of the second support pin group operate together in supporting the substrate W or in moving away from the substrate rear surface Wb to release the substrate W from supporting. While there may be at least three support pins in each support pin group in order to support the substrate W horizontally, since the number of the support pins in each support pin group is twelve, it is possible to support the substrate W stably.

FIG. 4 is a partial enlarged view showing a structure of the support pin. Since each of the support pins F1 through F12 and S1 through S12 is identically structured, a detailed description of the structure is hereby made on one support pin F1 with reference to the drawing. The support pin F1 includes an abutting portion 61, a movable rod 62, an elevating driver 63, and a bellows 64. The abutting portion 61 is capable of abutting on and separating away from the under surface of the substrate W. The movable rod 62 supports the abutting portion 61 such that the abutting portion 61 is movable up and down. The elevating driver 63 includes a motor which moves the movable rod 62 up and down. The bellows 64 is provided so as to encircle the movable rod 62 to block the movable rod 62 and the elevating driver 63 from the surrounding atmosphere. The bellows 64 is made of PTFE (poly-tetrafluoroethylene) for example, and protects the movable rod 62 which is made of stainless steel (SUS), aluminum, or the like when the substrate W is processed by means of a chemical solution and the like. Further, it is desirable that the abutting portion 61 is made of PCTFE (poly-chlorotrifluoroethylene) considering chemical resistance. The top end of the bellows 64 is fixed on the underside of the abutting portion 61, whereas the bottom end of the bellows 64 is fixed on the top surface side of the spin base 15.

The elevating driver 63 drives the movable rod 62 by a stroke of 1 to several mm via a driving link portion (not shown) based on driving signals from the control unit 8, whereby the support pins F1 through F12 and S1 through S12 which are structured in the manner described above support the substrate W in the following manner. To be more specific, in a condition that the elevating driver 63 is not driven, each of the support pins F1 through F12 and S1 through S12 is biased upward with a biasing section (not shown) such as coil springs so as to support the substrate W at a predetermined height (substrate processing position). Hence, the substrate W is supported by both of the support pin groups, namely, the first support pin group consisting of the support pins F1 through F12 and the second support pin group consisting of the support pins S1 through S12. On the other hand, when the support pins S1 through S12 are driven downward against the biasing force, the abutting portions 61 of the support pins S1 through S12 separate away from the substrate rear surface Wb, leaving the substrate W supported only by the first support pin group consisting of the support pins F1 through F12. Further, when the support pins F1 through F12 are driven downward against the biasing force, the abutting portions 61 of the support pins F1 through F12 separate away from the substrate rear surface Wb, leaving the substrate W supported only by the second support pin group consisting of the support pins S1 through S12.

Description is to be continued by referring back to FIG. 1. A disc-shaped blocking member 5 which is opposed against the substrate W which is supported by the support pins F1 through F12 and S1 through S12 is disposed horizontally above the spin chuck 1. The blocking member 5 is attached to the bottom end of the rotation column 51 which is coaxially arranged with the rotation column 11 of the spin chuck 1 so as to be rotatable integrally. A blocking member rotating mechanism 53 is connected with the rotation column 51. A motor of the blocking member rotating mechanism 53 is driven in response to an operation command from the control unit 8, whereby the blocking member 5 is rotated about the rotation center A0. The control unit 8 controls the blocking member rotating mechanism 53 so as to synchronize with the chuck rotating mechanism 13, whereby the blocking member 5 is driven to rotate in the same rotating direction and at the same rotation speed as the spin chuck 1.

Further, the blocking member 5 is connected with the blocking member elevating mechanism 55. An actuator for elevating drive (such as an air cylinder for instance) is activated, whereby the blocking member 5 is close to and opposed against the spin base 15, and is adversely separated away from the spin base 15. Specifically, the control unit 8 controls the blocking member elevating mechanism 55 so that the blocking member 5 moves upward to a separated position sufficiently away above the spin chuck 1, during loading and unloading of the substrate W into and from the substrate processing apparatus. On the other hand, the blocking member 5 is moved down to a predetermined opposed position very close to the top surface Wf of the substrate W which is held by the spin chuck 1 when predetermined processing such as etching processing is performed to the substrate W. This causes the lower surface (substrate facing surface) 501 of the blocking member 5 and the substrate top surface Wf to be positioned facing closely with each other.

An opening in the center of the block member 5 and a hollow portion of the rotation column 51 form a gas supplying path 57. The gas supplying path 57 is connected with the gas supply unit 18, whereby a nitrogen gas is supplied to a space SP between the substrate top surface Wf and the lower surface 501 of the blocking member 5.

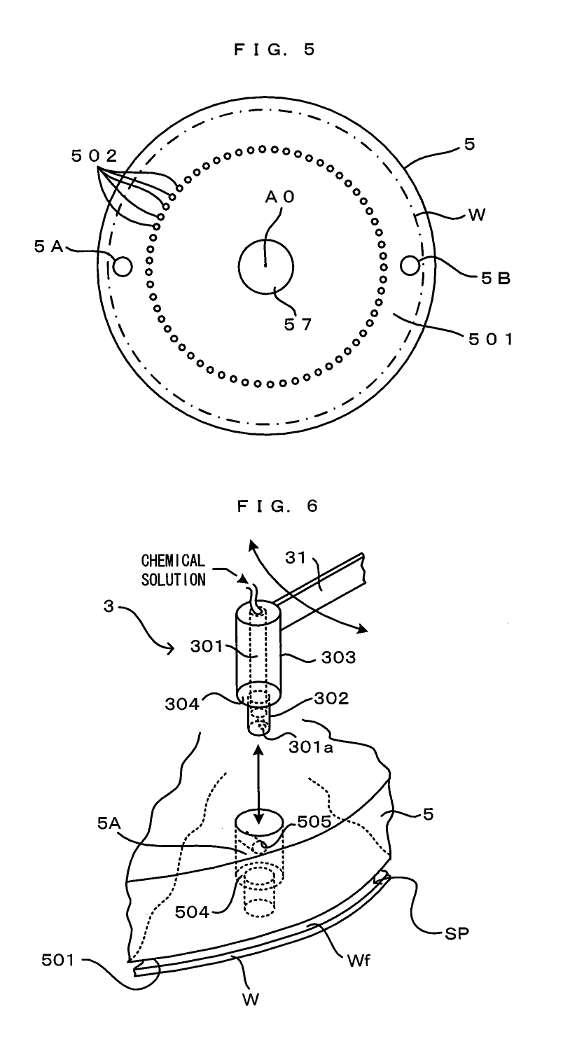

FIG. 5 is a bottom view of the blocking member 5. A plane size of the lower surface 501 of the blocking member 5 is formed equal to or larger than the diameter of the substrate W. Consequently, when the blocking member 5 is positioned at the opposed position, it covers the entire substrate surface, to thereby block the atmosphere above the substrate top surface Wf from the surrounding atmosphere. Further, nozzle insertion holes 5A and 5B which penetrate the blocking member 5 in the vertical axis direction and have an approximately cylindrical inner space are formed in the rim portion of the blocking member 5. The first nozzle 3 and the second nozzle 4 can be inserted into the nozzle insertion holes 5A and 5B separately. The nozzle insertion hole 5A and the nozzle insertion hole 5B are identical in shape and are positioned symmetrical to each other relative to the rotation center A0. On the other hand, the first nozzle 3 and the second nozzle 4 have identical external diameters. Therefore, both of the nozzles 3 and 4 can be inserted into either of the insertion holes 5A and 5B respectively.

Further, a plurality of gas discharging openings 502 are formed on the lower surface 501 of the blocking member 5. The plurality of gas discharging openings 502 are formed equiangularly along the circumference whose center is the rotation center A0 at the position opposite to the central portion of the surface of the substrate W which is held by the spin chuck 1, that is, at the position opposite to a non-processing region NTR which is radially inside of the top rim portion TR. These gas discharging openings 502 are communicated with a gas distribution space 503 (FIG. 1) formed inside the blocking member 5. Hence, when a nitrogen gas is supplied to the gas distribution space 503, the nitrogen gas is supplied to the space SP via the plurality of gas discharging openings 502.

When the nitrogen gas is supplied to the space SP from the plurality of gas discharging openings 502 and the gas supplying path 57 in a condition that the blocking member 5 is positioned at the opposed position, the internal pressure of the space SP rises to press the substrate W against the support pins F1 through F12 and S1 through S12 which abut on the rear surface Wb of the substrate W. Hence, when the spin base 15 rotates in accordance with the operation command of the control unit 8, the substrate W rotates together with the spin base 15 while being supported by the support pins F1 through F12 and S1 through S12 due to the frictional force generated between the substrate rear surface Wb and the support pins F1 through F12 and S1 through S12. Meanwhile, the nitrogen gas supplied to the space SP flows radially outside of the substrate W.

Description continues by referring back to FIG. 1. The first nozzle 3 is connected with the chemical solution supply unit 16. Hence, the chemical solution which serves as a “first processing liquid” of the invention is supplied from the chemical solution supply unit 16 to the first nozzle 3 in accordance with an operation command from the control unit 8. The chemical solution appropriate for etching a thin film (undesired substance) such as hydrofluoric acid, HPM solution (hydrochloric acid and hydrogen peroxide mixture) for example is used as the chemical solution. In this embodiment, the chemical solution of relatively high concentration is prepared in order to remove a thin film from each of the plurality of the substrates W to which thin films different from each other adhere respectively. In the case where hydrofluoric acid is used as the chemical solution for example, either undiluted hydrofluoric acid (or liquid of hydrogen fluoride) or hydrofluoric acid of relatively high concentration is prepared. This makes it possible to remove the thin film by etching from the substrate W without decreasing throughput, the thin film being not only the thin film which can be removed relatively easily by etching but also the thin film which is hardly-soluble in the chemical solution.

The first nozzle 3 is attached to one end of a nozzle arm 31 which extends horizontally. The other end of the nozzle arm 31 is connected with a first nozzle moving mechanism 33. The first nozzle moving mechanism 33 makes the first nozzle 3 horizontally pivot about the predetermined pivot shaft and move up and down. Therefore, when the first nozzle moving mechanism 33 is driven in accordance with an operation command from the control unit 8, the first nozzle 3 moves to a processing position P31 (equivalent of the “first processing position” of the invention) and to a stand-by position P32 (equivalent of the “first stand-by position” of the invention) which is separated away from the substrate W. The processing position P31 is a position at which the first nozzle 3 is inserted into the nozzle insertion hole 5A (or 5B) of the blocking member 5 and from which the chemical solution is supplied to the top rim portion TR.

Further, the second nozzle 4 is connected with the DIW supply unit 17. DIW is supplied from the DIW supply unit 17 to the second nozzle 4 in accordance with an operation command from the control unit 8. The second nozzle 4 supplies DIW, which serves as a rinsing liquid which washes away the chemical solution which remains adhering to the substrate W after the etching processing, to the top rim portion TR. Further, the second nozzle 4 supplies DIW, which serves as a “second processing liquid” of the invention which substantially suppresses the progression of the etching of the thin film by means of the chemical solution, to the top rim portion TR. To be more specific, DIW is supplied during etching processing from the second nozzle 4 to the top rim portion TR to which the chemical solution adheres, whereby the chemical solution is diluted and the progression of etching processing is suppressed (etching suppressing processing). Therefore, etching suppressing processing is executed during etching processing as described hereinafter, whereby the etching rate of the thin film is adjustable. Meanwhile, the rinsing liquid and the liquid used for etching suppressing processing (second processing liquid) may be, other than DIW, carbonated water, hydrogen water, diluted ammonia water (having the concentration of around 1 ppm for instance), diluted hydrochloric acid, or the like.

A second nozzle moving mechanism 43 which drives the second nozzle 4 has a structure similar to the first nozzle moving mechanism 33. Specifically, the second nozzle moving mechanism 43 makes the second nozzle 4 which is attached to the tip end of a nozzle arm 41 horizontally pivot about the predetermined pivot shaft and move up and down. Therefore, when the second nozzle moving mechanism 43 is driven in accordance with an operation command from the control unit 8, the second nozzle 4 moves to a processing position P41 (equivalent of the “second processing position” of the invention) and to a stand-by position P42 (equivalent of the “second stand-by position” of the invention) which is separated away from the substrate W. The processing position P41 is a position at which the second nozzle 4 is inserted into the nozzle insertion hole 5A (or 5B) of the blocking member 5 and from which DIW is supplied to the top rim portion TR.

At this stage, the nozzle insertion hole 5A and the nozzle insertion hole 5B are arranged at symmetrical positions relative to the rotation center A0. Hence, the angle between the line extending from the rotation center A0 to the processing position P31 and the line extending from the rotation center A0 to the processing position P41 is 180 degrees in a plan view.

By the arrangement described above, the control unit 8 makes the first nozzle moving mechanism 33 and the second nozzle moving mechanism 43 drive while controlling the chemical solution supply unit 16 and the DIW supply unit 17, an etching mode is selectively switched between two etching modes different from each other described below in accordance with the type of the thin film. Specifically, the control unit 8 selectively switches an etching mode between a first etching mode and a second etching mode.

The first etching mode is a mode which positions the first nozzle 3 at the processing position P31 and supplies the chemical solution from the first nozzle 3 to the top rim portion TR of the rotating substrate W.

The second etching mode is a mode which positions the second nozzle 4 at the processing position P41 and supplies DIW from the second nozzle 4 to the top rim portion TR to which the chemical solution adheres, while supplying the chemical solution to the top rim portion TR of the rotating substrate W from the first nozzle 3 which is positioned at the processing position P31.

Thus, in this embodiment, the first nozzle 3 and the first nozzle moving mechanism 33 function as the “bevel etching section” of the invention, and the second nozzle 4 and the second nozzle moving mechanism 43 function as the “etching suppressing section” of the invention.

Next, structures of the first and the second nozzles 3 and 4, and structures of the nozzle insertion holes 5A and 5B which are provided in the blocking member 5 are described. Both of the nozzles 3 and 4 are identically structured except for the fact that the types of discharging liquid are different. Further, both of the nozzle insertion holes 5A and 5B are formed in the blocking member 5 in the same configuration and at the symmetrical positions relative to the rotation center A0. Consequently, only a structure of the first nozzle 3 and a structure of the nozzle insertion hole 5A are described with reference to FIG. 6.

FIG. 6 is a diagram showing structures of the first nozzle 3 and the nozzle insertion hole 5A which is provided in the blocking member 5. The first nozzle 3 is formed approximately cylindrically to match the shape of the nozzle insertion hole 5A which is provided in the blocking member 5. When the first nozzle 3 is inserted into the nozzle insertion hole 5A, the tip end of the first nozzle 3 is positioned opposed against the top rim portion TR (FIG. 1). A liquid supplying path 301 is formed inside the first nozzle 3, and the tip end portion (bottom end portion) of the liquid supplying path 301 constitutes a discharging opening 301a of the first nozzle 3. The outside diameter of the first nozzle 3 is formed to be from about 5 mm to about 6 mm for example, so as not to unnecessarily enlarge the hole diameter of the nozzle insertion hole 5A. The first nozzle 3 is arranged in such a manner that the cross-sectional area of the tip end of a nozzle barrel which is shaped approximately cylindrically is different from that of the rear end of the nozzle barrel. Specifically, the first nozzle 3 is arranged in such a manner that the cross-sectional area of a barrel 302 which is in the tip end side of the nozzle is smaller than the cross-sectional area of a barrel 303 which is in the rear end side of the nozzle, and a stepped surface 304 is formed between the barrel 302 which is in the tip end side of the nozzle and the barrel 303 which is in the rear end side of the nozzle. In other words, an outer circumferential surface (side surface) of the barrel 302 which is in the tip end side of the nozzle and an outer circumferential surface (side surface) of the barrel 303 which is in the rear end side of the nozzle are connected via the stepped surface 304. The stepped surface 304 is formed so as to encircle the barrel 302 which is in the tip end side of the nozzle and to be approximately parallel to the top surface Wf of the substrate which is held by the spin chuck 1.

An abutting surface 504 in a form of a ring which can abut on the stepped surface 304 of the first nozzle 3 is formed on the internal wall of the nozzle insertion hole 5A. And when the first nozzle 3 is inserted into the nozzle insertion hole 5A, the stepped surface 304 abuts on the abutting surface 504, whereby the first nozzle 3 is positioned at the processing position P31. The tip end surface surrounding the discharging opening 301a of the first nozzle 3 is flush with the opposed surface 501 of the blocking member 5 when the first nozzle 3 is positioned at the processing position P31. The abutting surface 504 is formed approximately in parallel with the opposed surface 501 of the blocking member 5, that is, approximately in parallel with the substrate top surface Wf, and hence, the abutting surface 504 is in contact with the stepped surface 304 of the first nozzle 3 in a plane. Consequently, when the first nozzle 3 is positioned at the processing position P31, the first nozzle 3 is securely positioned abutting on the blocking member 5, and it is possible to position the first nozzle 3 in a stable manner.

The discharging opening 301a of the first nozzle 3 is open outward in a radial direction of the substrate W so that the chemical solution can be discharged from the discharging opening 301a to the top rim portion TR. The liquid supplying path 301 is connected with the chemical solution supply unit 16 at the rear end of the nozzle. Consequently, when the chemical solution is pumped from the chemical solution supply unit 16 to the liquid supplying path 301, the chemical solution is discharged from the first nozzle 3 outward in a radial direction of the substrate W. Hence, the chemical solution supplied to the top rim portion TR flows outward in a radial direction of the substrate W, and outflows to the outside of the substrate. Therefore, the chemical solution is not supplied to the non-processing region NTR which is inside of the supplying position of the chemical solution in a radial direction, and the thin film is removed by etching in a constant width (rim etching width) inward from the edge surface of the substrate W. Further, in the same way as the first nozzle 3, the discharging opening of the second nozzle 4 is open outward in a radial direction of the substrate W so that DIW can be discharged from the discharging opening to the top rim portion TR. Consequently, when the DIW is pumped from the DIW supply unit 17 to the second nozzle 4, the DIW is discharged from the second nozzle 4 outward in a radial direction of the substrate W. Hence, the DIW is supplied to the top rim portion TR, flows outward in a radial direction of the substrate W, and outflows to the outside of the substrate.

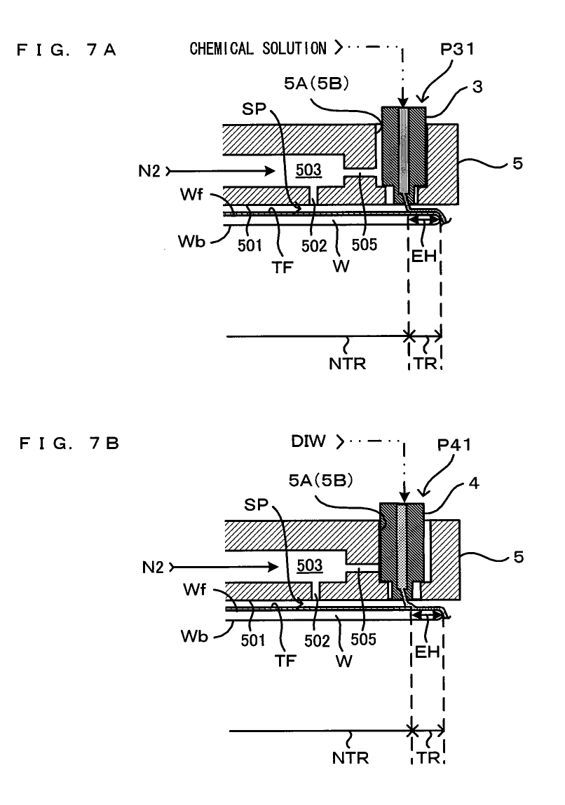

FIGS. 7A and 7B are sectional views for describing the relationships between the outside diameters of the first and the second nozzles 3 and 4 and the hole diameters of the nozzle insertion holes 5A and 5B. The hole diameters of the nozzle insertion holes 5A and 5B are formed to be larger than the outside diameters of the first and the second nozzle 3 and 4. This makes it possible to position the first nozzle 3 and the second nozzle 4 at different positions from each other in a horizontal direction in the internal space within the nozzle insertion holes 5A and 5B. Therefore, in this embodiment, the processing position P41 (FIG. 7B) of the second nozzle 4 is set inward in a radial direction of the substrate W (leftward in FIGS. 7A and 7B) relative to the processing position P31 of the first nozzle 3. It is desirable to form the hole diameters of such nozzle insertion holes 5A and 5B to be larger than the outside diameters of the first and the second nozzles 3 and 4 by about 1 to 2 mm, and the processing position P41 is set to be positioned inward in a radial direction of the substrate W relative to the processing position P31 by 0.2 to 0.5 mm for example.

Further, gas introduction inlets 505 are opened in the internal walls of the nozzle insertion holes 5A and 5B to allow nitrogen gas to be supplied from the gas introduction inlets 505 to the internal spaces within the nozzle insertion holes 5A and 5B. The gas introduction inlets 505 are communicated with the gas supply unit 18 via a gas distribution space 503 formed inside the blocking member 5. Therefore, when the nitrogen gas is pumped from the gas supply unit 18, the nitrogen gas is supplied to the internal space within the nozzle insertion holes 5A and 5B. Hence, the nitrogen gas is discharged from both of the openings at the top end and the rear end of the nozzle insertion holes 5A and 5B, in a condition that the first nozzle 3 and the second nozzle 4 are positioned at the stand-by positions P32 and P42 respectively, that is, in a condition that the first and the second nozzles 3 and 4 are not inserted into the nozzle insertion holes 5A and 5B. Therefore, even when the nozzles are not inserted into the nozzle insertion holes 5A and 5B, the processing liquid is prevented from adhering to the internal walls of the nozzle insertion holes 5A and 5B.

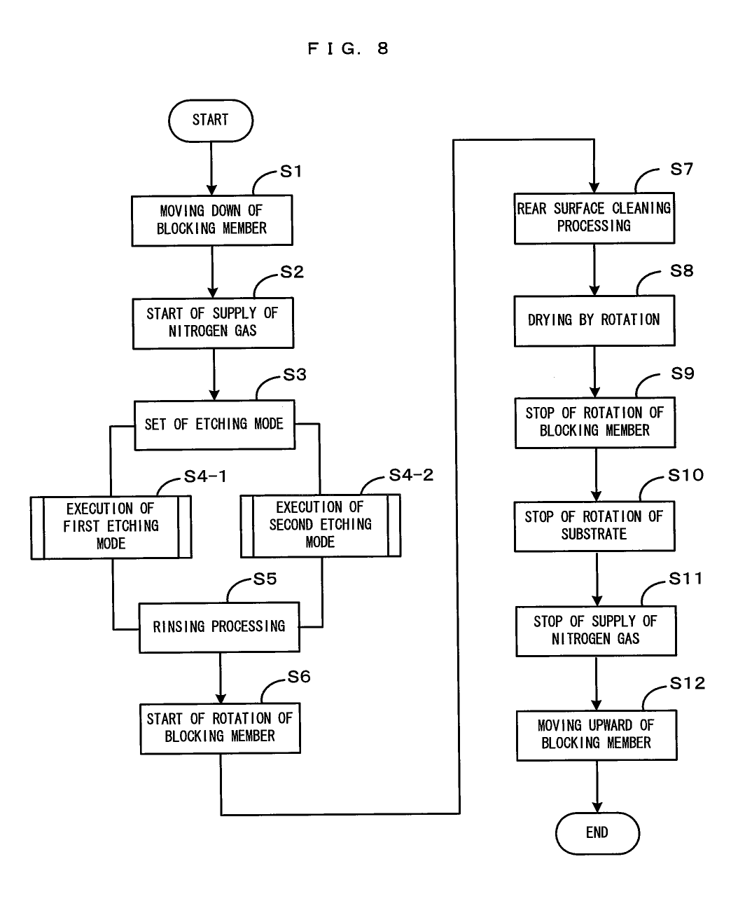

Next, an operation of the substrate processing apparatus structured as described above is described by referring to FIGS. 8 through 12B. FIG. 8 is a flow chart showing an operation of the substrate processing apparatus shown in FIG. 1. In this apparatus, when the substrate W yet to be processed is loaded into inside the apparatus, the control unit 8 controls respective portions of the apparatus, whereby a sequence of film removing processing (chemical solution processing step+rinsing step+drying step) is performed to the substrate W. At this stage, a thin film TF (FIG. 7) is formed on the substrate top surface Wf. That is, the substrate top surface Wf is the surface on which the thin film is formed. Consequently, in this embodiment, the substrate W is loaded into the apparatus with the substrate top surface Wf facing upward. Meanwhile, the blocking member 5 is positioned at the separated position to prevent the interference with the substrate W.

When the unprocessed substrate W is placed on the support pins F1 through F12 and S1 through S12, the blocking member 5 is moved down to the opposed position and is positioned close to the substrate top surface Wf (Step S1). Then, the nitrogen gas is discharged from the gas discharging openings 502, and the nitrogen gas is supplied from the gas supplying path 57 toward the central portion of the substrate top surface Wf (Step S2). This increases an internal pressure in the space SP between the lower surface 501 of the blocking member 5 and the substrate top surface Wf, whereby the substrate W is pressed against the support pins F1 through F12 and S1 through S12 which abut on its under surface (rear surface Wb) to be held by the spin base 15. Further, the substrate top surface Wf is covered with the lower surface 501 of the blocking member 5, whereby the substrate top surface Wf is securely blocked from the outside atmosphere surrounding the substrate. Meanwhile, the substrate W may be supported by all of the support pins F1 through F12 and S1 through S12 as described above, or may be supported only by the first support pin group consisting of the support pins F1 through F12, or may be supported only by the second support pin group consisting of the support pins S1 through S12.

Subsequently, a chemical solution processing is performed to the substrate W. Specifically, when an operator chooses a processing recipe via an operating panel (not shown) of the substrate processing apparatus, an etching mode (the first etching mode or the second etching mode) corresponding to the type of the thin film is set (Step S3) and the set etching mode is executed. For the processing recipe, a plurality of job data (one-line data) which correspond to the types of the thin film and in which the chemical solution and the etching mode used are interrelated with each other are stored in a memory 81 (FIG. 2) of the control unit 8 in advance. Consequently, the first etching mode is performed for the thin film which is hardly soluble in the chemical solution for example (Step S4-1), whereas the second etching mode is performed for the thin film which is relatively easily removed by etching (Step S4-2) in accordance with the content of the processing recipe. Thus, in this embodiment, it is possible to remove the thin film by etching in the etching mode suitable for the type of the thin film by choosing the processing recipe.

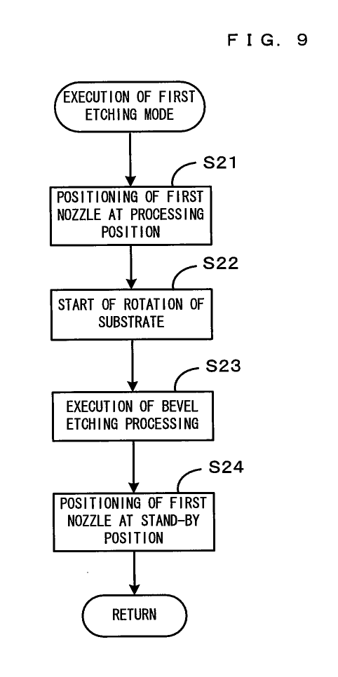

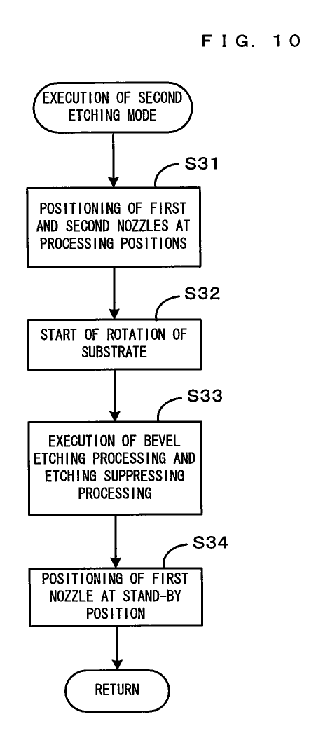

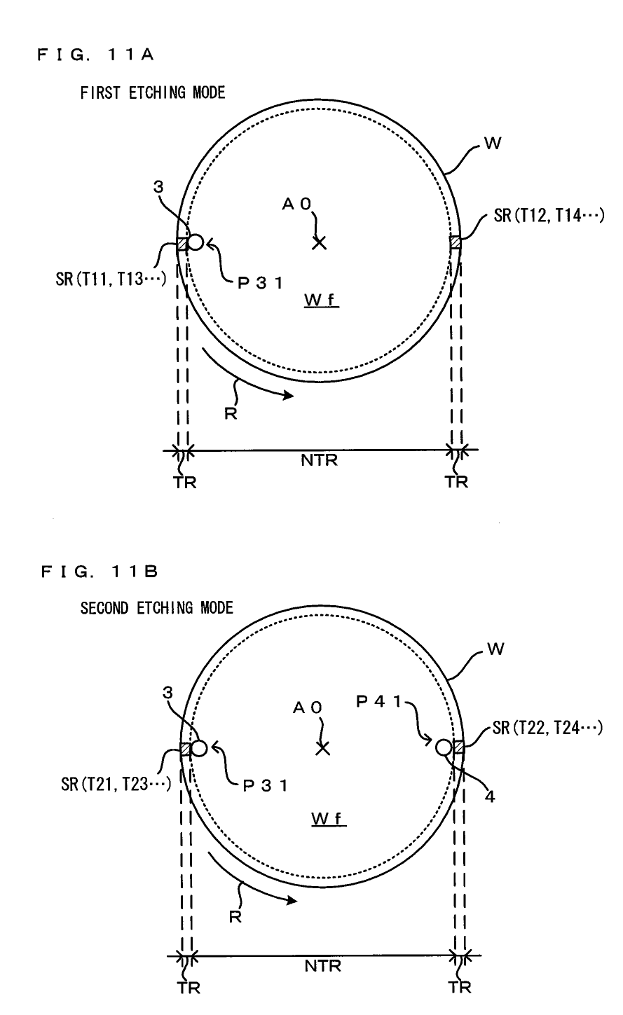

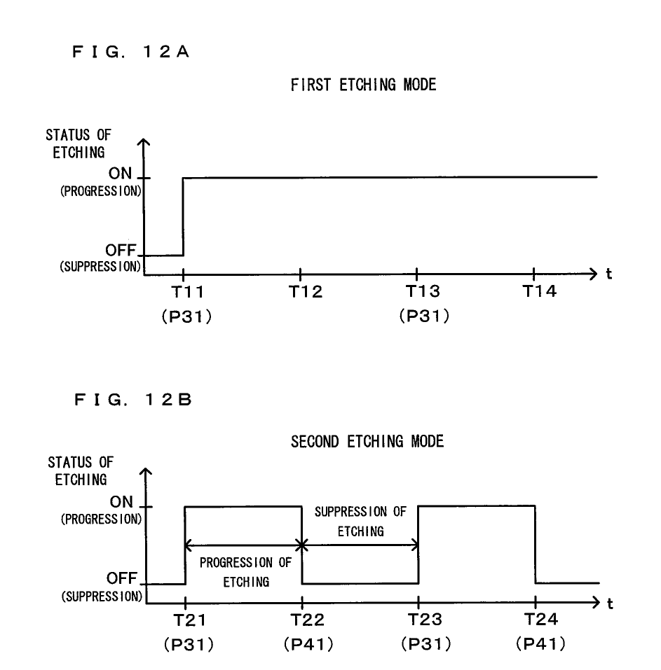

Next, a description on the mechanism of the removal of the thin film by etching from the top rim portion TR of the substrate W in the first etching mode and the second etching mode is made with reference to FIGS. 9 through 12B. FIGS. 9 and 10 are flow charts showing contents executed in the first etching mode and the second etching mode, respectively. Further, FIGS. 11A and 11B are plan views for describing the mechanism of the removal of the thin film by etching in the first etching mode and the second etching mode, respectively. Furthermore, FIG. 12A is a timing chart showing a progression of etching in a micro region SR at respective timings T11 to T14 in the first etching mode, and FIG. 12B is a timing chart showing a progression of etching in a micro region SR at respective timings T21 to T24 in the second etching mode. The reference characters SR(T11) to SR(T14) in FIG. 11A indicate positions of the particular micro region SR in the top rim portion TR at respective timings T11 to T14, and the reference characters SR(T21) to SR(T24) in FIG. 11B indicate positions of the particular micro region SR in the top rim portion TR at respective timings T21 to T24. Further, in FIGS. 12A and 12B, “ON” indicates that the etching of the thin film is in progress, whereas “OFF” indicates that the progression of the etching of the thin film is suppressed.

First, a description is made in the case where the first etching mode is executed in accordance with the type of the thin film formed on the substrate-to-be-processed W with reference to FIGS. 9, 11A and 12A. In this first etching mode, the first nozzle 3 is moved from the stand-by position P32 and is positioned at the processing position P31 (Step S21). Specifically, the first nozzle 3 is moved horizontally to the position above the nozzle insertion hole 5A (or 5B) of the blocking member 5. Then, the first nozzle 3 is moved down to be inserted into the nozzle insertion hole 5A (or 5B). Subsequently, the substrate W is rotated in a condition that the blocking member 5 is stopped (Step S22). At this stage, the substrate W pressed against the support pins F1 through F12 and S1 through S12 rotates together with the spin base 15 while held by the spin base 15 due to a friction force generated between the support pins F1 through F12 and S1 through S12 and the substrate rear surface Wb.

When the rotation speed of the substrate W reaches a predetermined speed (600 rpm for instance), the chemical solution is supplied continuously from the first nozzle 3 to the top rim portion TR of the rotating substrate W. Hence, the thin film is removed by etching from the whole circumference of the top rim portion TR and the portion of the substrate edge surface extending from the top rim portion TR (Step S23; bevel etching processing). To be more specific, when the chemical solution is supplied from the first nozzle 3 toward the micro region SR of the top rim portion TR of the substrate W as shown in FIG. 11A, etching processing to the micro region SR starts (at the timing T11). Then, although a part of the chemical solution supplied to the micro region SR is shaken off due to the centrifugal force associated with the rotation (rotating direction R) of the substrate W, the thin film is gradually removed from the micro region SR by etching with time by means of the chemical solution remaining to adhere to the micro region SR (at the timing T12). Further, when the substrate W completes its one rotation, the new chemical solution is supplied from the first nozzle 3 to the micro region SR and the thin film is further removed by etching from the micro region SR (at the timing T13). After this, the thin film continues to be removed by etching from the micro region SR by means of the chemical solution adhering to the micro region SR (at the timing T14).

In this way, etching to the micro region SR continuously progresses from the time when the supply of the chemical solution to the micro region SR is started in the first etching mode as shown in FIG. 12A. Thus, when the chemical solution processing for a predetermined time period is completed, the supply of the chemical solution is stopped and the first nozzle 3 is moved from the processing position P31 and is positioned at the stand-by position P32 (Step S24). Meanwhile, the positioning of the first nozzle 3 at the stand-by position P32 may be performed after the rinsing processing to be described hereinafter.

Subsequently, a description is made in the case where the second etching mode is executed in accordance with the type of the thin film formed on the substrate-to-be-processed W with reference to FIGS. 10, 11B and 12B. In this second etching mode, the first and the second nozzles 3 and 4 are moved from the stand-by positions P32 and P42 and are positioned at the processing positions P31 and P41, respectively (Step S31). Specifically, the first nozzle 3 is inserted into the nozzle insertion hole 5A (or 5B), whereas the second nozzle 4 is inserted into the nozzle insertion hole 5B (or 5A). Subsequently, the substrate W is rotated while the blocking member 5 is stopped (Step S32).

Then, at the same time as the start of the supply of DIW from the second nozzle 4, or after the start of the supply of DIW, the chemical solution is started to supply from the first nozzle 3. Hence, the thin film is removed by etching from respective portions of the top rim portion TR, while bevel etching processing (bevel etching step) of the thin film by means of the chemical solution and etching suppressing processing (etching suppressing step) by means of the DIW are performed (Step 33). To be more specific, when the chemical solution is supplied to the micro region SR from the first nozzle 3 as shown in FIG. 11B, etching processing to the micro region SR is started (at the timing T21). Then, the thin film is removed from the micro region SR by etching with time by means of the chemical solution adhering to the micro region SR. When the DIW is supplied from the second nozzle 4 to the micro region SR by the rotation of the substrate W, the chemical solution adhering to the micro region SR is diluted by the DIW, whereby the progression of the etching of the thin film is substantially suppressed (at the timing T22). That is, after the DIW is supplied to the micro region SR, the progression of the etching of the thin film in the micro region SR is suppressed. Further, when the substrate W makes one rotation, the new chemical solution is supplied to the micro region SR from the first nozzle 3 and etching processing to the micro region SR is started again (at the timing T23). After this, when the substrate W rotates and the DIW is supplied to the micro region SR again, the progression of the etching of the thin film in the micro region SR is suppressed (at the timing T24).

In this way, etching of the thin film progresses and the thin film is removed by etching from each portion of the top rim portion TR when the micro region SR is positioned between the downstream of the processing position P31 and the upstream of the processing position P41 in a rotation direction R of the substrate W in the second etching mode as shown in FIG. 12B. On the other hand, the progression of etching of the thin film is substantially suppressed when the micro region SR is positioned between the downstream of the processing position P41 and the upstream of the processing position P31 in the rotation direction R of the substrate W. Hence, etching rate of the thin film can be decreased compared with that of the first etching mode. In this way, when the chemical solution processing for a predetermined time is completed, the supply of the chemical solution is stopped and the first nozzle 3 is moved from the processing position P31 and is positioned at the stand-by position P32 (Step S34).

At this stage, since the processing position P41 of the second nozzle 4 is positioned inward in a radial direction of the substrate W relative to the processing position P31 of the first nozzle 3, the DIW can be supplied to a region which includes an area where the chemical solution is supplied and which is broader than the area where the chemical solution is supplied. Therefore, the DIW is securely supplied to the boundary between the top rim portion (processing region) TR and the non-processing region NTR of the central portion of the top surface, whereby the progression of the etching to the non-processing region NTR by means of the chemical solution adhering to the boundary is prevented. Therefore, the processing can be executed while the rim etching width EH (FIG. 7) is controlled accurately and uniformly around the overall circumference.

Particularly in the case where the thin film such as TEOS film formed on a top surface of silicon substrate is removed from the top rim portion by means of hydrofluoric acid, it is effective to set the processing positions P31 and P41 in a manner described above. The reason is that when the thin film is removed from the top rim portion by means of the hydrofluoric acid, the top rim portion exhibits a hydrophobic property, whereas the thin film adhering to the non-processing region NTR which is radially inside of the top rim portion TR exhibits a hydrophilic property. Consequently, the hydrofluoric acid tends to remain adhering to the boundary between the top rim portion (processing region) TR and the non-processing region NTR, and the situation is such that the etching to the non-processing region NTR is easy to progress. Therefore, even in such case, by supplying the DIW to the boundary between the top rim portion TR and the non-processing region NTR in such a manner that the DIW is supplied from radially inside toward outside, it is possible to securely prevent the etching from progressing into the non-processing region NTR.

When the chemical solution processing is completed as described above, rinsing processing is executed to the top rim portion TR (Step S5). To be more specific, after the chemical solution processing in the first etching mode, the second nozzle 4 is moved from the stand-by position P42 and is positioned at the processing position P41. Then, DIW which serves as a rinsing liquid is supplied from the second nozzle 4 to the top rim portion TR. Hence, rinsing processing is performed to the top rim portion TR and to the substrate edge surface portion extending from the top rim portion TR. On the other hand, after the chemical solution processing in the second etching mode, rinsing processing is performed to the top portion TR and the edge surface of the substrate W by means of the DIW supplied from the second nozzle 4 which is already positioned at the processing position P41. To be more specific, the DIW which has been supplied to the substrate W together with the chemical solution during the chemical solution processing in the second etching mode continues to be supplied to the substrate W, whereby the rinsing processing is performed.

Thus, when the rinsing processing for a predetermined time is completed, the supply of the DIW is stopped and the second nozzle 4 is moved from the processing position P41 and is positioned at the stand-by position P42. Subsequently, the blocking member 5 is rotated at approximately the same rotation speed and in the same direction as that of the spin base 15 (Step S6). Then, the processing liquid is supplied from the under surface processing nozzle 2 to the rear surface Wb of the rotating substrate W, and a rear surface cleaning processing is executed to the substrate rear surface Wb (Step S7). Specifically, the chemical solution and the rinsing liquid are supplied sequentially as the processing liquid from the under surface processing nozzle 2 toward the central portion of the substrate rear surface Wb, whereby the entire rear surface and the substrate edge surface portion extending from the rear surface Wb are cleaned. Thus, rotating the blocking member 5 together with the substrate W prevents the processing liquid adhering to the blocking member 5 from causing negative impact on the process. This also suppresses development of excessive airflow associated with the rotation between the substrate W and the blocking member 5, to thereby prevent mist-like processing liquid from getting into the substrate top surface Wf.

At this stage, the support pins F1 through F12 and S1 through S12 are moved away from the substrate rear surface Wb at least once during the cleaning processing, whereby the processing liquid is flowed over to the abutting portions of the substrate rear surface Wb where the support pins F1 through F12 and S1 through S12 abut to the substrate rear surface Wb to clean the portions. For example, a condition that the substrate W is supported by both of the support pin groups, namely, the first support pin group consisting of the support pins F1 through F12 and the second support pin group consisting of the support pins S1 through S12, is switched during the cleaning processing to a condition that the substrate W is supported only by the first support pin group, whereby the processing liquid is flowed over to the abutting portions where the support pins of the second support pin group abut to the substrate W. Subsequently, after the condition is shifted to the condition that the substrate W is supported by both of the support pin groups, the condition is switched to a condition that the substrate W is supported only by the second support pin group, whereby the processing liquid is flowed over to the abutting portions where the support pins of the first support pin group abut to the substrate W. Hence, the processing liquid is flowed over to all of the abutting portions where the support pins F1 through F12 and S1 through S12 abut to the substrate W, whereby the cleaning processing is performed to the entire rear surface.

When the rear surface cleaning processing is thus completed, the substrate W and the blocking member 5 are rotated at high speed (1500 rpm for example). Consequently, the drying of the substrate W is executed (Step S8). At this time, nitrogen gas is supplied also from the gas supplying path 23 together with the supply to the substrate top surface Wf, whereby the nitrogen gas is supplied to both of the surfaces of the substrate W and the drying processing of the substrate W is accelerated.

When the drying processing of the substrate W is completed, the rotation of the blocking member 5 is stopped (Step S9), and the rotation of the substrate W is stopped (Step S10). Then, the supply of nitrogen gas from the gas supplying path 57 and the gas discharging openings 502 is stopped, whereby the substrate W is released from being pressed and held against the support pins F1 through F12 and S1 through S12 (Step S1). After this, the blocking member 5 is moved upward and the processed substrate W is unloaded from the apparatus (Step S12).

As described above, according to this embodiment, the etching mode can be selectively switched between the two etching modes (the first and the second etching modes) different from each other in accordance with the type of the thin film adhering to the substrate W. That is, it is possible to set the etching rate of the thin film in two levels in accordance with the type of the thin film. Hence, the thin film can be removed from the top rim portion TR at the appropriate etching rate corresponding to the type of the thin film. Therefore, it is possible to excellently remove the thin film from the top rim portion TR regardless of the type of the thin film.

Meanwhile, the etching rate of the undesired substance of the first etching mode is the value (quotient) the etching amount of the undesired substance is divided by the etching processing time during which the etching of the undesired substance is performed. On the other hand, the etching rate of the undesired substance of the second etching mode is the value (quotient) the etching amount of the undesired substance is divided by the total processing time which is the sum of the etching processing time and the etching suppressing processing time during which the progression of the etching of the undesired substance is suppressed.

Further, according to this embodiment, it is possible to remove the thin film by etching from the top rim portion TR at the appropriate etching rate regardless of the type of the thin film by preparing only the chemical solution of relatively high concentration. To be more specific, according to this embodiment, even in the case where etching processing is performed to each of a plurality of substrates to which the thin films of which the types are different from each other are adhered respectively, it is possible to excellently remove the thin films from the top rim portion TR without preparing the chemical solution of which the concentrations are different from each other for each of the substrates. Therefore, the embodiment offers excellent versatility while simplifying the structure of the apparatus.

Further, according to this embodiment, since the etching rate is adjusted by performing the etching suppressing processing described above during bevel etching processing, the following advantage is obtained. That is, the etching rate of the thin film can be adjusted also by changing parameters such as the rotation speed of the substrate or the supply quantity of the chemical solution during the etching processing. However, adjusting the etching rate of the thin film by changing these parameters negatively affects other process performances (uniformity of the rim etching width, prevention of the chemical solution from splashing, etc.). Further, changing these parameters for the respective substrates-to-be-processed hamper stable execution of etching processing. On the contrary to all of the above, according to this embodiment, the etching rate can be adjusted without negatively affecting other process performances, and hence, it is possible to stably execute etching processing regardless of the types of the thin film adhering to the substrates-to-be-processed.

Furthermore, according to this embodiment, when the first and the second nozzles 3 and 4 are positioned at the processing positions P31 and P41 respectively, the first and the second nozzles 3 and 4 are inserted into the nozzle insertion holes 5A and 5B respectively. Consequently, even in the case where the processing liquid spatters and is splashed back toward the nozzles (the first and the second nozzles 3 and 4) during etching processing, the processing liquid is blocked by the lower surface 501 of the blocking member 5. Hence, a large quantity of processing liquid would not adhere to the nozzles. Therefore, the situation that the processing liquid drops from the nozzles, adheres to the substrate W or to the substrate peripheral members, and causes adverse effect on them is prevented.

Further, in this embodiment, a holding member such as a chuck pin which contacts outer circumferential portion of the substrate W to hold the substrate W is not provided. Therefore, the processing liquid shaken off radially outward from the rotating substrate W would not hit such a holding member to splash back to the substrate top surface Wf. Moreover, although such holding member could be a factor which disturbs airflow in the vicinity of the outer circumferential portion of the substrate W, the absence of this factor reduces the mist-like processing liquid flowing into the side of the substrate top surface Wf. Further, in this embodiment, the nitrogen gas supplied from the gas supplying path 57 and the gas discharging openings 502 to the space SP between the substrate top surface Wf and the lower surface of the blocking member 5 prevents the chemical solution from entering into the non-processing region NTR of the central portion of the top surface. Therefore, the undesired substance can be removed by etching from the top rim portion TR with the rim etching width EH constant and uniformly around the overall circumference.

### Second Embodiment

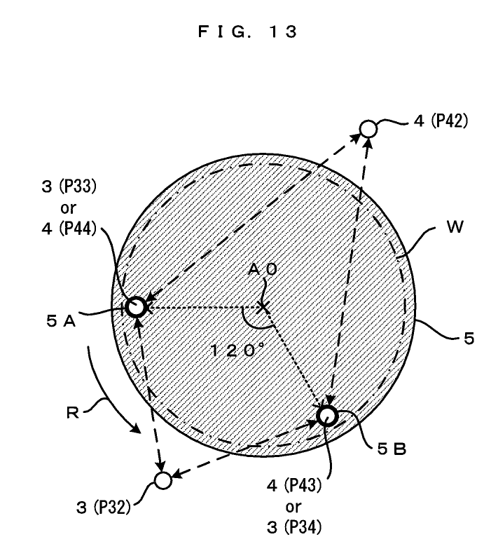

FIG. 13 is a plan view showing a second embodiment of the substrate processing apparatus according to the invention. The substrate processing apparatus of the second embodiment differs greatly from that of the first embodiment in the following points. To be more specific, in the first embodiment, the angle between the line extending from the rotation center A0 to the processing position of the first nozzle 3 and the line extending from the rotation center A0 to the processing position of the second nozzle 4 is 180 degrees in a plan view. On the other hand, in this second embodiment, the angle between the line extending from the rotation center A0 to the processing position of the first nozzle 3 and the line extending from the rotation center A0 to the processing position of the second nozzle 4 is 120 degrees in a plan view.

Further, due to the change of the processing positions of the first and the second nozzles 3 and 4, the positions of the two nozzle insertion holes 5A and 5B formed in the blocking member are changed in accordance with the processing positions of the first and the second nozzles 3 and 4. Specifically, the angle between the line extending from the rotation center A0 to the nozzle insertion hole 5A and the line extending from the rotation center A0 to the nozzle insertion hole 5B, namely, the angle from the former line to the latter line in the rotation direction R of the substrate W is 120 degrees. Since the other arrangement and the operations are basically similar to those of the first embodiment, the description herein is focused on the differences.

In this embodiment, the first nozzle 3 is moved between the processing position P33 and the stand-by position P32 and between the processing position P34 and the stand-by position P32. At this stage, the processing position P33 is a position at which the first nozzle 3 is inserted into the nozzle insertion hole 5A and is capable of supplying the chemical solution to the top rim portion TR, and the processing position P34 is a position at which the first nozzle 3 is inserted into the nozzle insertion hole 5B and is capable of supplying the chemical solution to the top rim portion TR.

Further, the second nozzle 4 is moved between the processing position P43 and the stand-by position P42 and between the processing position P44 and the stand-by position P42. At this stage, the processing position P43 is a position at which the second nozzle 4 is inserted into the nozzle insertion hole 5B and is capable of supplying the DIW to the top rim portion TR, and the processing position P44 is a position at which the second nozzle 4 is inserted into the nozzle insertion hole 5A and is capable of supplying the DIW to the top rim portion TR.

The stand-by position P32 is located on the perpendicular bisector of the line segment whose endpoints are the point at the processing position P33 and the point at the processing position P34, and outside of the blocking member 5 in a radial direction. And, the stand-by position P42 is located on the perpendicular bisector of the line segment whose endpoints are the point at the processing position P44 and the point at the processing position P43, and outside of the blocking member 5 in a radial direction. Further, the stand-by position P32 is positioned across the rotation center A0 from the stand-by position P42. This facilitates easy driving control (positioning) of the first nozzle 3 from the stand-by position P32 to the processing positions P33 and P34 and of the second nozzle 4 from the stand-by position P42 to the processing positions P43 and P44. This also prevents the first nozzle 3 and the second nozzle 4 from interfering with each other.

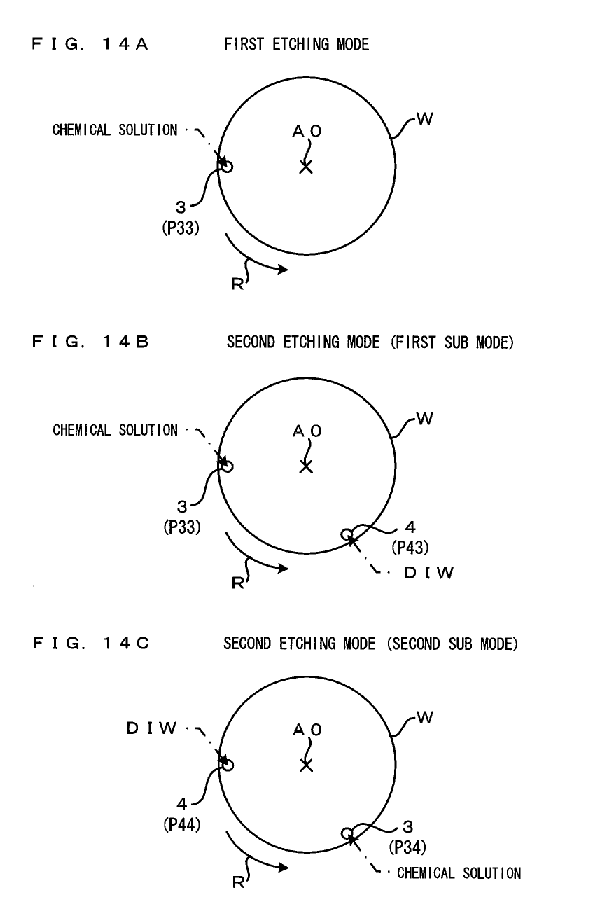

Next, description is made on an operation of the substrate processing apparatus arranged in an aforementioned manner with reference to FIGS. 14A to 14C. FIGS. 14A, 14B and 14C are diagrams schematically showing operations of the substrate processing apparatus shown in FIG. 13. In this second embodiment, the etching mode can be selectively switched among three etching modes (the first etching mode, a first sub mode of the second etching mode, and a second sub mode of the second etching mode) different from each other in accordance with the type of the thin film. To be more specific, the control unit 8 selectively switches the etching mode to the first etching mode, a first sub mode of the second etching mode, and a second sub mode of the second etching mode.

The first etching mode is a mode which positions the first nozzle 3 at the processing position P33 (or P34) and supplies the chemical solution to the top rim portion TR of the rotating substrate W as shown in FIG. 14A.

The first sub mode of the second etching mode is a mode which positions the second nozzle 4 at the processing position P43 and supplies the DIW to the top rim portion TR to which the chemical solution adheres, while supplying the chemical solution to the top rim portion TR of the rotating substrate W from the first nozzle 3 positioned at the processing position P33 as shown in FIG. 14B.

The second sub mode of the second etching mode is a mode which positions the second nozzle 4 at the processing position P44 and supplies the DIW to the top rim portion TR to which the chemical solution adheres, while supplying the chemical solution to the top rim portion TR of the rotating substrate W from the first nozzle 3 positioned at the processing position P34 as shown in FIG. 14C.

At this stage, as described in the first embodiment, when the first etching mode is executed, the thin film adhering to the top rim portion TR is removed by etching (bevel etching processing) from the top rim portion TR by means of the chemical solution from the first nozzle 3 without etching suppressing processing being executed.

Further, when the first sub mode of the second etching mode is executed, etching processing progresses between the downstream side of the processing position P33 and the upstream side of the processing position P43 in the rotation direction R of the substrate W, and the thin film is removed by etching from each portion of the top rim portion TR. On the other hand, the progression of etching processing between the downstream side of the processing position P43 and the upstream side of the processing position P33 in the rotation direction R of the substrate W is substantially suppressed. To be more specific, while the substrate W rotates one turn (360 degrees in terms of the rotation angle of the substrate W), etching processing of the thin film progresses during the rotation of ⅓ turn (120 degrees in terms of the rotation angle of the substrate W), whereas the progression of the etching of the thin film is substantially suppressed during the rotation of the remaining ⅔ turn (240 degrees in terms of the rotation angle of the substrate W).

Further, when the second sub mode of the second etching mode is executed, etching processing progresses between the downstream side of the processing position P34 and the upstream side of the processing position P44 in the rotation direction R of the substrate W, and the thin film is removed by etching from each portion of the top rim portion TR. On the other hand, the progression of the etching processing between the downstream side of the processing position P44 and the upstream side of the processing position P34 in the rotation direction R of the substrate W is substantially suppressed. To be more specific, while the substrate W rotates one turn (360 degrees in terms of the rotation angle of the substrate W), the etching processing of the thin film progresses during the rotation of ⅔ turn (240 degrees in terms of the rotation angle of the substrate W), whereas the progression of the etching of the thin film is substantially suppressed during the rotation of the remaining ⅓ turn (120 degrees in terms of the rotation angle of the substrate W).

Therefore, comparison of the etching rates of the thin film in the above mentioned three etching modes indicates that the etching rate of the thin film declines in the order of the first etching mode, the second sub mode of the second etching mode, and the first sub mode of the second etching mode.

As described above, according to this embodiment, the etching mode is selectively switched among three etching modes different from each other in accordance with the type of the thin film, whereby the etching rate of the thin film can be set at three levels. Therefore, even in the case where the type of the thin film is different from each of the substrates-to-be-processed, it is possible to flexibly manage in accordance with the difference of the type of the thin film. Furthermore, since the angle between the line extending from the rotation center A0 to the processing position of the first nozzle 3 and the line extending from the rotation center A0 to the processing position of the second nozzle 4 is set at 120 degrees in a plan view, it is possible to change the etching rate of the thin film relatively widely by the switch of the etching mode. To be more specific, in terms of the etching processing time for executing etching, the time of the first sub mode of the second etching mode is one-third of that of the first etching mode, and the time of the second sub mode of the second etching mode is two-thirds of that of the first etching mode. Hence, it is possible to widely adjust the etching rate of the thin film in accordance with the type of the thin film.

<Others>

The invention is not limited to the embodiments described above but may be modified in various manners in addition to the embodiments above, to the extent not deviating from the object of the invention. For example, in the above embodiments, although the etching mode is switched in accordance with the type of the thin film (undesired substance) adhering to the substrate W, the timing at which the etching mode is switched is not limited to this. For instance, even in the case where a plurality of substrates to which the same type of the thin film adheres, there may be a case that the thickness of the thin film is different from each of the substrates due to the difference of the film forming method on the substrate W and the like. Even in such a case, the etching mode may be switched for each substrate in accordance with the thickness of the adhering thin film, whereby the thin film may be removed by etching from the top rim portion TR at an appropriate etching rate corresponding to the thickness of the thin film. Therefore, it is possible to excellently remove the thin film from the top rim portion TR regardless of the properties (the type of the thin film and the thickness of the thin film) of the undesired substance.

Further, in the above embodiments, the chemical solution is supplied to the top rim portion TR from the side of the substrate top surface Wf, whereby the thin film which exists on the top rim portion TR is removed by etching (bevel etching processing) from the top rim portion TR. However, the method of bevel etching processing is not limited to this. For example, the chemical solution supplied to the rear surface Wb of the rotating substrate W may be made flow over to the top rim portion TR via the edge surface of the substrate W, whereby the thin film which exists on the top rim portion TR may be removed by etching from the top rim portion TR.

Further, in the embodiments above, the DIW is supplied to the top rim portion TR to which the chemical solution adheres, whereby the progression of the etching of the thin film by means of the chemical solution adhering to the top rim portion TR is suppressed. However, the method of the etching suppressing processing is not limited to this. For instance, the progression of etching of the thin film by means of the chemical solution adhering to the top rim portion TR may be suppressed by supplying the DIW intermittently toward the center of the substrate top surface Wf. To be more specific, the DIW is supplied toward the center of the rotating substrate W from the side of the substrate surface Wf, whereby the DIW spreads by the centrifugal force so as to be supplied to the entire circumference of the top rim portion TR. Consequently, the progression of the etching of the thin film by means of the chemical solution is suppressed throughout the entire circumference of the top rim portion TR during the DIW is supplied to the top rim portion TR. Therefore, it is possible to adjust the etching rate of the thin film by controlling the duty ratio, which is a ratio between the DIW supplying time and the DIW supply stopping time.

Further, in the second embodiment above, the angle between the line extending from the rotation center A0 to the first processing position (the processing position P33 for instance) of the first nozzle 3 and the line extending from the rotation center A0 to the second processing position (the processing position P43 for instance) of the second nozzle 4 is 120 degrees in a plan view. However, the angle is not limited to this as long as it is not 180 degrees. Even with this arrangement, it is possible to switch the etching mode between the first sub mode of the second etching mode in which the first processing position is at the upstream of the second processing position relative to the rotation direction R of the substrate W, and the second sub mode of the second etching mode in which the first processing position is at the downstream of the second processing position relative to the rotation direction R of the substrate W, in addition to the first etching mode. Therefore, the etching mode can be selectively switched among the three etching modes different from one another in accordance with the property of the undesired substance, hence, it is possible to set the etching rate of the undesired substance at three levels.

Further, in the above embodiments, the first and the second nozzles 3 and 4 are inserted into the nozzle insertion holes 5A and 5B formed in the blocking member 5 when the first and the second nozzles 3 and 4 are positioned at the processing positions at which the chemical solution can be supplied to the top rim portion TR. However, it is not always necessary to insert the first and the second nozzles 3 and 4 into the nozzle insertion holes 5A and 5B. For example, a blocking member of which the size is smaller than that of the substrate W in a plan view may be positioned opposed to the substrate top surface Wf, and the first and the second nozzles 3 and 4 may be positioned close to the side wall of the blocking member. Furthermore, only the first and the second nozzles 3 and 4 may be positioned at the side of the substrate top surface Wf without positioning the blocking member 5 opposed to the substrate top surface Wf.

Further, in the above embodiments, the substrate W is pressed against the supporting members such as the support pins F1 through F12 and S1 through S12 which abut on the substrate rear surface Wb, whereby the substrate W is held. However, holding members such as chuck pins may abut on the outer circumferential portion of the substrate W to hold the substrate W.

Further, in the above embodiments, although the substrate processing apparatus is provided with one nozzle for each of the first nozzle 3 and the second nozzle 4, the number of each nozzle is not limited to one, and the apparatus may be provided with a plurality of the nozzles. Further, with regard to the nozzle insertion hole in the blocking member 5, two nozzle insertion holes are formed in the blocking member 5 corresponding to the first and the second nozzles 3 and 4 in the above embodiments, but more than two nozzle insertion holes may be formed. For instance, more than two nozzle insertion holes may be formed at positions of which an angle is different from each other in a plan view, the angle being an angle between the line extending from the rotation center A0 to the first processing position and the line extending from the rotation center A0 to the second processing position. According to this arrangement, the first and the second nozzles 3 and 4 are appropriately inserted into either two out of more than two nozzle insertion holes in accordance with the property of the undesired substance, whereby a ratio is changed at multiple levels, the ratio being a ratio of an etching processing time to a total processing time which is a total of the etching processing time in which etching of undesired substance is performed and a processing time in which the progression of etching of undesired substance is suppressed. Therefore, it is possible to set the etching rate of the undesired substance at multiple levels in accordance with the property of the undesired substance.

The present invention is applicable to a substrate processing apparatus and a substrate processing method which performs bevel etching processing to a surface of substrates in general including semiconductor wafers, glass substrates for photomask, glass substrates for liquid crystal display, glass substrates for plasma display, substrates for FED (field emission display), substrates for optical disks, substrates for magnetic disks, substrates for magnet-optical disks, etc.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A substrate processing apparatus, comprising:
a bevel etching section which supplies a first processing liquid to a rim portion of a substrate top surface and removes by etching undesired substance which is present on the rim portion by means of the first processing liquid to execute a bevel etching processing;
an etching suppressing section which supplies a second processing liquid to the rim portion of the substrate top surface to which the first processing liquid adheres and substantially suppresses a progression of etching of the undesired substance by means of the first processing liquid to execute an etching suppressing processing, wherein
the etching suppressing section executes the etching suppressing processing in accordance with a property of the undesired substance while the bevel etching section executes the bevel etching processing, and accordingly an etching rate of the undesired substance is adjusted.

2. The substrate processing apparatus of claim 1, further comprising a controller which controls the bevel etching section and the etching suppressing section to selectively switch in accordance with the property of the undesired substance between a first etching mode in which only the bevel etching processing is executed without the etching suppressing processing being executed and a second etching mode in which the etching suppressing processing is executed while the bevel etching processing is executed.

3. The substrate processing apparatus of claim 2 in which the undesired substance is removed by etching from the rim portion of the top surface of the substrate which is approximately circular, the apparatus further comprising:
a substrate holder which holds the substrate approximately horizontally in a condition that the substrate top surface is directed toward above; and
a rotator which rotates the substrate held by the substrate holder, wherein
the bevel etching section includes a first nozzle which supplies the first processing liquid to the rim portion of the substrate top surface from a side of the substrate top surface, and a first nozzle moving mechanism which moves the first nozzle between a first processing position from which the first processing liquid can be supplied to the rim portion of the substrate top surface and a first stand-by position which is away from the substrate,
the etching suppressing section includes a second nozzle which supplies the second processing liquid to the rim portion of the substrate top surface from a side of the substrate top surface, and a second nozzle moving mechanism which moves the second nozzle between a second processing position which is a position different from the first processing position and from which the second processing liquid can be supplied to the rim portion of the substrate top surface and a second stand-by position which is away from the substrate, and
the controller executes the first etching mode in which the first nozzle is positioned at the first processing position and the first processing liquid is supplied from the first nozzle, whereas executes the second etching mode in which the second nozzle is positioned at the second processing position and the second processing liquid is supplied to the rim portion of the substrate top surface to which the first processing liquid adheres while the first processing liquid is supplied from the first nozzle positioned at the first processing position.

4. The substrate processing apparatus of claim 3, wherein an angle between a line extending from a rotation center of the substrate to the first processing position and a line extending from the rotation center of the substrate to the second processing position is 180 degrees in a plan view.

5. The substrate processing apparatus of claim 3, wherein an angle between a line extending from a rotation center of the substrate to the first processing position and a line extending from the rotation center of the substrate to the second processing position is different from 180 degrees in a plan view, and
the controller selectively switches etching modes between a first sub mode and a second sub mode in addition to the first etching mode, both of the sub modes serving as the second etching mode, the first sub mode having the first processing position at the upstream side of the second processing position in a rotating direction of the substrate, and the second sub mode having the first processing position at the downstream side of the second processing position in the rotating direction of the substrate.

6. The substrate processing apparatus of claim 3, wherein the second processing position is inside of the first processing position in a radial direction of the substrate.

7. The substrate processing apparatus of claim 3, further comprising a blocking member which is disposed closely and opposed to the substrate top surface, and in which a plurality of nozzle insertion holes, into which the first nozzle and the second nozzle can be inserted separately and which penetrate in a vertical direction, are formed at positions opposed to the rim portion of the substrate top surface, wherein
the first nozzle moving mechanism and the second nozzle moving mechanism insert the first nozzle and the second nozzle into either one of the plurality of the nozzle insertion holes to position the nozzles at the first processing position and the second processing position, respectively.

8. The substrate processing apparatus of claim 7, wherein
the blocking member includes a substrate opposed surface which is opposed to the substrate top surface and on which a gas discharging opening is formed, and
the substrate holder includes a rotation member which is rotatable about a vertical axis, at least three supporting members which are disposed projecting upward on the rotating member and abut on the rear surface of the substrate so as to support the substrate in a condition separated away from the rotating member, and a gas supplier which supplies gas to a space between the substrate opposed surface and the substrate top surface so as to press the substrate against the supporting members.

9. A substrate processing method, comprising:
a bevel etching step of supplying a first processing liquid to a rim portion of a substrate top surface to remove undesired substance which is present on the rim portion by etching from the rim portion by means of the first processing liquid; and
an etching suppressing step of supplying a second processing liquid to the rim portion of the substrate top surface to which the first processing liquid adhere to substantially suppress progression of etching of the undesired substance by means of the first processing liquid, wherein the etching suppressing step is executed in accordance with a property of the undesired substance while the bevel etching step is executed to adjust an etching rate of the undesired substance.
